(19) United States
(12) Patent Application Publication
(10) Pub. No.: US 2026/0340626 A1
(43) Pub. Date: Oct. 29, 2026

(54) SETTLEMENT ENGINE FOR CROSS PAYMENT SYSTEM PAYMENTS

(71) Applicants: Stepan ROMANKOV, Frankfurt am Main (DE); James BROWNLEE, Bath (GB)

(72) Inventors: Stepan ROMANKOV, Frankfurt am Main (DE); James BROWNLEE, Bath (GB)

(21) Appl. No.: 19/192,018

(22) Filed: Apr. 28, 2025

(51) Int. Cl. G06Q 20/38; G06Q 20/40; G06Q 40/04

(52) U.S. Cl. CPC G06Q 20/381; G06Q 20/389; G06Q 20/405; G06Q 40/04

(57) ABSTRACT

In various examples a settlement engine maintains a settlement ledger which is a data structure holding functional data to facilitate cross payment-system payments. The settlement engine processes requests for cross payment-system payments by using the settlement ledger and this results in secure, efficient and highly scalable infrastructure for cross payment system payments.

### TECHNICAL FIELD

The present disclosure relates to a settlement engine for managing a settlement ledger to achieve efficient secure cross payment-system payments.

### BACKGROUND

A payment system is a process for transfer of monetary value between parties. A payment system is used in lieu of tendering cash. A non-exhaustive list of examples of payment system is: Faster Payments System (FPS), Single Euro Payments Area (SEPA), Automated Clearing House (ACH) System, credit card network, automated teller machine network, automated clearing house, real-time gross settlement, and the SWIFT network. A cross payment system payment occurs when monetary value is transferred between two parties, where each party is using a different payment system. Where a payment is a cross-border payment the payment is also typically a cross payment system payment, since different jurisdictions often have different payment systems.

Cross payment system payments are slow and expensive, and often involve multiple different intermediaries. Security is a significant problem since any tampering or disturbance of a cross payment system payment by a malicious party may lead to financial losses. Scalability is another challenge since the demand for cross payment system payments is increasing and yet infrastructure for implementing secure, efficient cross payment system payments is difficult to scale.

The examples described herein are not limited to examples which solve problems mentioned in this background section.

### SUMMARY

Examples of preferred aspects and embodiments of the invention are as set out in the accompanying independent and dependent claims.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A settlement engine uses a settlement ledger to enable cross payment system payments.

In various examples, a computer-implemented method is performed by a settlement engine for fulfilling cross payment system payments. A memory stores a settlement ledger between a plurality of members of a settlement network, wherein each member has an entry in the settlement ledger specifying a settlement limit which is dynamically adjustable by the member, and wherein transactions made via the members are recorded in the settlement ledger. The settlement engine receives quotes from the members over secure channels. The quotes are for converting between a first currency and a settlement currency, and between the settlement currency and a second currency where the first and second currencies are in different payment systems. The quotes may be joined together to provide a combined quote for converting between the first currency and the second currency. The settlement engine receives, via the secure channel, from a first member, a notification that a sender has initiated a transfer of money to a recipient, wherein the sender sends the money in the first currency, and wherein the recipient receives the money in the second currency. The settlement engine matches, between the first member and a second member, quotes for transferring the money from the first member in the first currency, via the settlement currency, to the second member in the second currency. The settlement engine sends, via the secure channel, to the first member, the matched quotes. The settlement engine receives via the secure channel, from the first member, a notification that money has been received by the first member from the sender in the first currency. The settlement engine triggers the second member, in response to receiving the notification that money has been received by the first member, to send money in the second currency to the recipient. The settlement engine receives via the secure channel, from the second member, a notification that money has been transferred from the second member to the recipient in the second currency. The settlement engine sends via the secure channel, to the first member, a notification that the second member has transferred money to the recipient in the second currency. The settlement engine updates the settlement ledger in the memory to reflect the transfer of money from the sender to the recipient via the first member and second member.

Other examples will become apparent from the following detailed description, which, when taken in conjunction with the drawings, illustrate by way of example the principles of the disclosed technology.

### BRIEF DESCRIPTION OF THE DRAWINGS

FIG. 1A is a schematic diagram of a settlement engine and settlement ledger deployed in a communications network;

FIG. 1B is a flowchart of an example method performed by a settlement engine such as that of FIG. 1A;

FIG. 2 is a flow chart of another example of the operations undertaken between the sender and the first member, and, the recipient and the second member;

FIG. 3 is a flowchart of additional optional operations; and

FIG. 4 is a schematic diagram of a computer which may be used to deploy a settlement engine and/or settlement ledger for cross payment system payments.

The accompanying drawings illustrate various examples. The skilled person will appreciate that the illustrated element boundaries (e.g., boxes, groups of boxes, or other shapes) in the drawings represent one example of the boundaries. It may be that in some examples, one element may be designed as multiple elements or that multiple elements may be designed as one element. Common reference numerals are used throughout the figures, where appropriate, to indicate similar features.

### DETAILED DESCRIPTION

The following description is made for the purpose of illustrating the general principles of the present technology and is not meant to limit the inventive concepts claimed herein. As will be apparent to anyone of ordinary skill in the art, one or more or all of the particular features described herein in the context of one embodiment are also present in some other embodiment(s) and/or can be used in combination with other described features in various possible combinations and permutations in some other embodiment(s).

As mentioned above, cross payment system payments are slow and expensive, and often involve multiple different intermediaries. There are technical challenges in creating and deploying infrastructure for cross payment system payments, to give security, scalability and efficiency.

One method of cross payment system payment uses a correspondent bank which is capable of holding large sums of money in two different currencies each being from a different payment system involved in a cross payment system transaction. A sender sending money from a first country in a first currency via a first bank uses a correspondent bank which holds money in both the first currency and second currency. The correspondent bank will then send the money in the second currency to a second bank in a second country which transfers the money to the recipient. The Swift messaging system is used to communicate the balance transfers between the two participating banks. This method has several associated disadvantages. Notably, the transactions can take between 1 and 15 days to complete depending on the countries involved. Additionally, some corridors (route between a first and second country) can be difficult to serve and require several correspondent banks. This results in slow and expensive transactions due to the cost of making each currency exchange along the corridor. It is not straightforward to scale up the equipment and infrastructure of the various correspondent banks and corridors.

A second method of cross payment system payment uses floats of multiple currencies in each country. A bank will maintain a float in multiple different currencies in multiple different countries around the world. The singular bank will handle all the money coming in and leaving the bank. The downside to this second method is that it is difficult to scale since the singular bank has limited infrastructure and processing capacity. Additionally, it is difficult to scale to new countries as the singular bank needs to be licensed to operate in all the new countries and needs to be able to maintain and manage pre-funded bank accounts in every currency in every new country. The second method is not robust since failure of infrastructure at the singular bank prevents operation of the cross payment system payments.

Another approach to implementing cross payment system payments uses “stablecoin” sandwiches to facilitate transfer of funds across borders/payment systems. The idea behind this method is that the first bank in the first country converts the first currency into a stablecoin (e.g. USDC) and transfers the stablecoin to the second bank in the second country. The second bank then converts the stablecoin into a second currency. This method is not scalable because it requires two conversions for each transaction, resulting in inefficiency and increased complexity and security risk. [we have not mentioned poor liquidity management and costly conversions because those a business problems and the patent office is looking for technical problems].

In various examples a settlement engine maintains a settlement ledger which is a data structure holding functional data to facilitate cross payment-system payments. The settlement engine processes requests for cross payment-system payments by using the settlement ledger and this results in secure, efficient and highly scalable infrastructure for cross payment system payments.

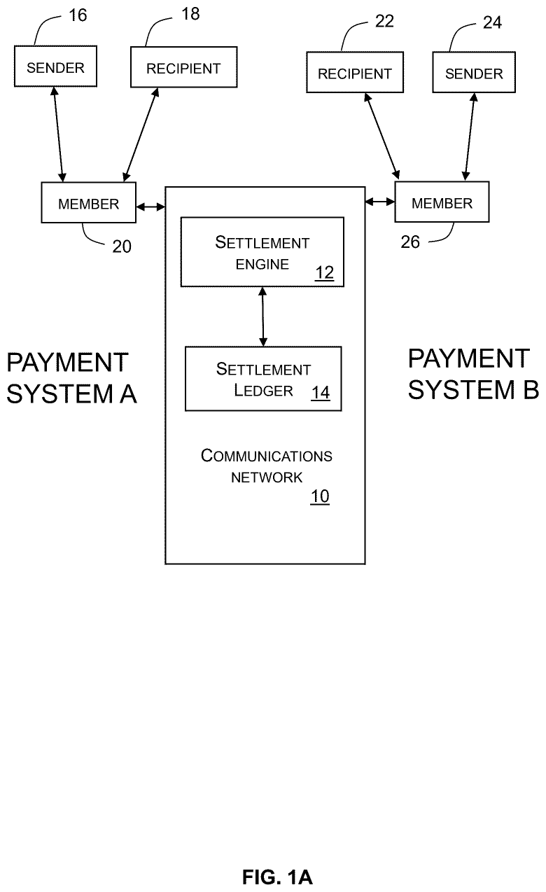

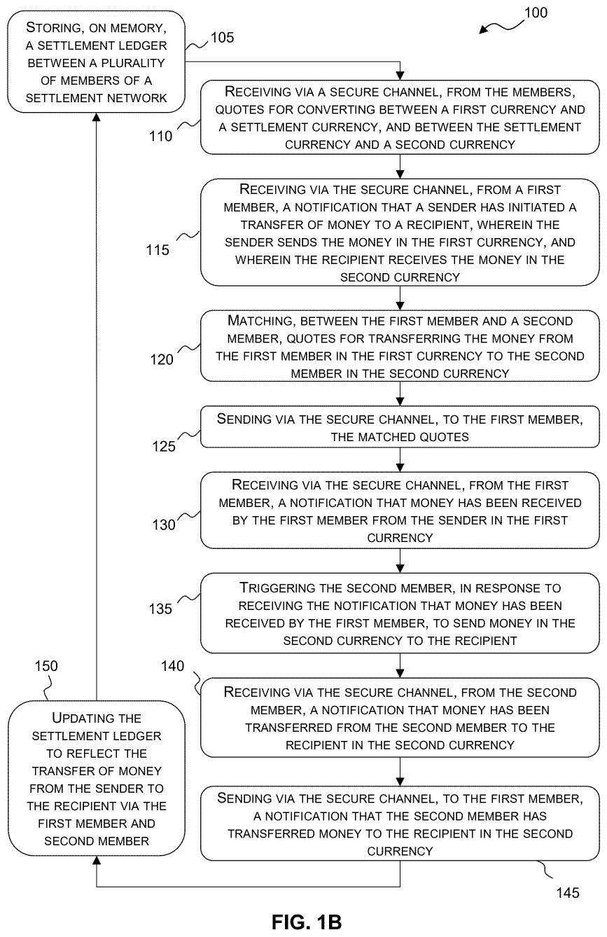

FIG. 1A is a schematic diagram of a settlement engine 12 and settlement ledger 14 deployed in a communications network 10. The settlement engine is computer implemented. The settlement ledger 14 is a data structure stored in secure memory at a location accessible to the settlement engine 12. The settlement ledger 14 is distributed in some cases and in some cases is stored using distributed ledger technology although that is not essential. The settlement engine 12 and settlement ledger 14 are deployed in a communications network such as an intranet or the internet. Computing systems of members 20, 26 are able to communicate with the settlement engine 12 via communications network 10 in a secure manner, such as using secure communication channels established using cryptographic keys or certificates. A member is an entity that has registered with the settlement engine and has been authenticated and verified by the settlement engine. A non-limiting example of a member is a payment service provider. By having the settlement engine only accept communications from member computing systems that are registered, denial of service attacks on the settlement engine are mitigated.

Each member computing system is accessible to a sender computing system 16 and a recipient computing system 18. A sender computing system 16 may be a computing system of a bank where an individual or organization requiring to send a cross payment system payment has an account. The sender computing system 16 may be a computing system of a bank or financial technology company that provide their customers with a method of making cross system payments. The sender computing system 16 may additionally be a business that implements a user interface to enable their customers to obtain quotes from the settlement ledger 14. A recipient computing system 18 may be a computing system of a bank where an individual or organization requiring to receive a cross payment system payment has an account. FIG. 1A shows two members 20, 26 with computing systems that are configured to operate in different payment systems (member 20 has a computing system configured for payment system A and member 26 has a computing system configured for payment system B).

The settlement ledger stores settlement limit data dynamically received from computing systems of the members 20, 26 over secure communication channels. The term “dynamically” means the settlement limit data may change during live operation of the settlement engine 12. The settlement engine and settlement ledger are carefully designed to facilitate dynamic updating of the settlement limit data during live operation. Requests to update settlement limit data received by the settlement engine from different members may be processed in parallel thus enabling real time updating while the settlement engine is in use to process live cross payment system payments. Parallel processing is facilitated by having independent settlement limit entries in the settlement ledger. For each pair of members a settlement limit is stored in the settlement ledger and since the settlement limit entries are independent of one another parallel processing of requests to update settlement limits of different pairs of members are possible. The settlement engine receives multiple requests from different members in real time during operation of the cross payment system payments.

The settlement ledger contents are made available to the member computing systems in a secure manner. Because the members have access to the information in the settlement ledger, which is a trusted secure source of data, the member computing systems are able to work together to enable cross payment system payments. In order to achieve this, a mechanism to enable members to query content of the settlement ledger in real time, during live operation of cross payment system payments is implemented. The queries and responses are transmitted over secure communication channels so as to be protected from eavesdroppers. In some cases the contents of the settlement ledger are displayed at a member computing system over a secure web browser.

FIG. 1B of the accompanying drawings is a flowchart outlining a computer-implemented method 100 performed by a settlement engine such as that of FIG. 1A. The term “sender” refers to a computing device and associated software used by a party to send a payment. The term “recipient” refers to a computing device and associated software used by a party to receive a payment.

At Operation 105, a settlement ledger is generated. The settlement ledger is a data structure holding functional data. The settlement ledger is accessible to a plurality of members of a settlement network and is stored on memory which may be distributed. The settlement ledger keeps track of transactions between the members of the settlement network. Members are able to query the settlement ledger by sending a query over a secure channel to find settlement limits for each of the plurality of members. A settlement limit is assigned between two or more of the plurality of members, denoting the maximum amount of debt that one member may have with another member. In this context, debt signifies a first member making payouts to recipients in a first currency on behalf of a second member, wherein the total value of the payouts made by the first member in the first currency on behalf of the second member is larger than the total value of the payouts being made to recipients by the second member in the second currency on behalf of the first member. Once a settlement limit for one or more of the members has been reached, settlement occurs by transferring an asset over a secure channel. This means that an indefinite number of transactions may occur between each of the members before a given settlement limit is reached. As each member may act as both a sender or a receiver, transactions may occur in either direction, resulting in outbound transactions and inbound transactions between the members offsetting each other. The offsetting of outbound and inbound transactions permits the members to make a large volume of transactions before having to make a settlement payment. In doing so, the members can scale up the number of transactions and the monetary value of the transaction they can offer to parties.

A pair of members settle with each other by transferring an agreed settlement asset. For example, they may transfer FIAT currency, a crypto asset, or any other form of suitable asset. By doing so, only one settlement needs to be made once the settlement limit has been reached, as opposed to settling each individual transaction between the members.

At Operation 110, currency exchange quotes are received from the plurality of members. The currency exchange quotes are for exchanging a first currency to a settlement currency and for exchanging the settlement currency into a second currency. The currency exchange quotes may be streamed live so as to accurately reflect market exchange rates between the first and second currency. The quotes may arrive with different bands associated with the monetary value of the transactions. For example, the quotes may be divided up into the following bands: <1000, 1000-9999, and, >10,000. The exchange rates on offer may improve as the monetary value of the transaction increases into the upper band.

At Operation 115, a notification that a sender has initiated a transfer of money to a recipient is received from a first member of the plurality of members. Prior to Operation 115, a sender makes an inquiry with the first member regarding transferring money to the recipient. The first member notifies the settlement network of this request for a transfer of money. The first member in this instance may be a payment service provider operating in the same country as the sender.

Once the notification that the sender has initiated a transfer of money is received, quotes for converting the money from a first currency which the sender is sending money in, to a settlement currency, and for converting the settlement currency to a second currency to be received by the recipient are matched at Operation 120. The quotes may be matched so as to offer the sender the best possible exchange rates for the transaction in question. The matched quotes are then sent to the first member at Operation 125. The first member may make the quotes available to the sender so that the sender may calculate how much money to send in the first currency and how much money the recipient will receive in the second currency in view of the amount of money sent in the first currency. The first member may display to the sender an amount that needs to be sent in the first currency such that the recipient receives a set amount in the second currency, and/or, the first member may display to the sender an amount that will be received by the recipient in the second currency based on the amount that the sender wishes to send in the first currency to the recipient.

The sender will then accept the matched quotes and will transfer the money in the first currency to the first member. The first member then notifies the settlement engine, at Operation 130, that they have received the money from the sender in the first currency.

At Operation 135, a notification is sent to the second member informing them that the first member has received the correct amount of money (in the first currency) from the sender. The second member will then transfer the money to the recipient in the second currency.

At Operation 140, the second member notifies the settlement network that they have completed the transaction and transferred the money to the recipient in the second currency.

At Operation 145, a notification is then sent to the first member notifying them that the transaction has been completed and that the recipient has received the money in the second currency. The first member will then inform the sender that the transaction has been completed and may provide them with a receipt.

At Operation 150, the settlement ledger is updated to reflect the transaction between the first member and the second member. In this example, the first member has received funds from the sender, and, the second member has sent funds to the recipient. Therefore, the settlement ledger will reflect the fact that the first member now owes money to the second member, as the first member has received money and the second member has sent money.

The above operations are repeated indefinitely until a settlement limit is reached between the first and second member. Once this settlement limit has been reached, the first and second members settle with each other by making one or more transactions. Additionally, the settlement payment made between the first and second member may be “pre-funded”, i.e., one of the first or second members may make a settlement payment before any transactions occur in anticipation of the settlement limit between the first and second member being reached.

By providing a settlement ledger which reflects all the transactions to and from each of the members, members can indefinitely transfer money from senders to recipients and only need to repay each other once a settlement limit has been reached. For example, if two members in two countries are performing a plurality of transactions with senders and recipients in each respective currency, and the transactions are going in both directions (i.e., some are going from senders in the first country to recipients in the second country, and, some are going from senders in the second country to recipients in the first country), then these payments offset each other and the settlement limit between these two members may never be reached. This means that no settlement is required until a settlement limit is reached, reducing the requirement for members to regularly settle between each other. This reduces the computational power required to process settlements as less settling is required. Moreover, reducing the number of settlements (i.e., transactions between the members) reduces the likelihood of a breach of security. Each individual transaction has an associated security risk, and, therefore, reducing the number of transactions inherently reduces the risk of a security breach.

The effect of the method is that a sender sends money to a first member in a first currency, and, a recipient then receives money from a second member in a second currency. No money is being transferred between the first member and the second member, therefore, no computational power (or transaction cost) is being used to transfer the money between the members for a given transfer of money from a sender to a recipient. The only transaction that occurs between the first member and the second member is the settlement payment made once the settlement limit between the first and second member has been reached, which may occur after an indefinite number of transfers of money between senders and recipients. Therefore, the method beneficially reduces the computational power required to make cross payment system payments.

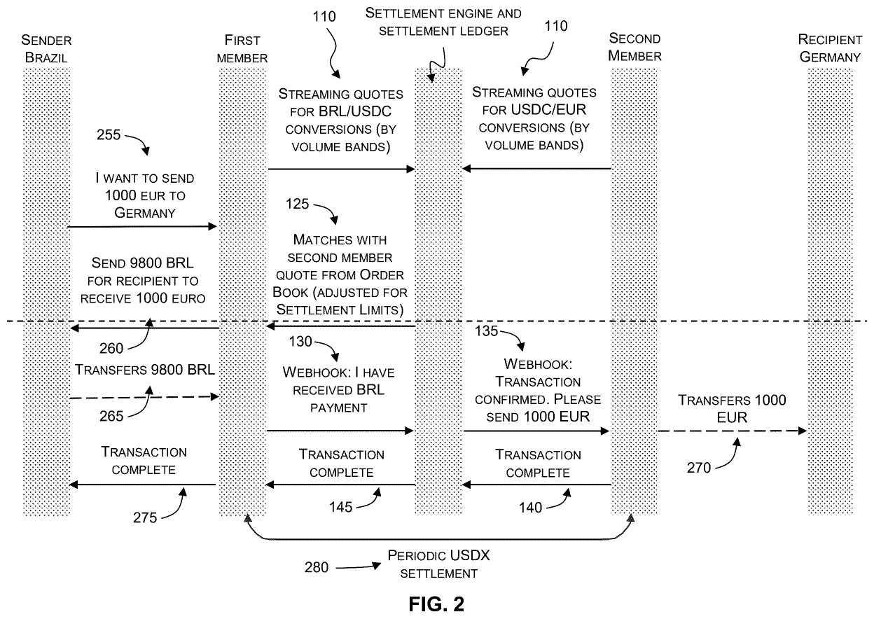

FIG. 2 is a flowchart of operations undertaken between a sender and a first member, and, a recipient and a second member. The example shown in FIG. 2 has a sender located in Brazil sending Brazilian Real to a recipient in Germany receiving Euros.

Operations shown in FIG. 2 which are already described above in relation to FIG. 1B are annotated using the same reference numerals as in FIG. 1B.

A transaction is initiated by a sender at Operation 255 contacting the first member to inquire about sending money in a first currency (e.g., Brazilian Real) to a recipient receiving the money in a second currency (e.g., Euros). The sender provides the first member with an amount of money the recipient is to receive in the second currency. The settlement engine provides the first member with matched quotes (Operation 125) for sending money in Brazilian Real to a recipient receiving Euros.

The first member provides the matched quotes to the sender at Operation 260, permitting the sender to determine how many of the first currency to send in order that the recipient receives the desired amount of the second currency.

At Operation 265, the sender sends the money in the first currency to the first member of the settlement network. The first member receiving the money in the first currency triggers Operations 130 and 135, which in turn triggers the second member to pay the recipient in the second currency and this is denoted as Operation 270 in FIG. 2.

Once payment is made to the recipient, Operations 140 and 145 are triggered, resulting in Operation 275 whereby the first member notifies the sender that the recipient has received the money.

Finally, at Operation 280, once a settlement limit has been reached between two or more of the members, a settlement payment is triggered, causing one or more of the members to transfer an asset to one or more of the other members such that the settlement ledger has been settled.

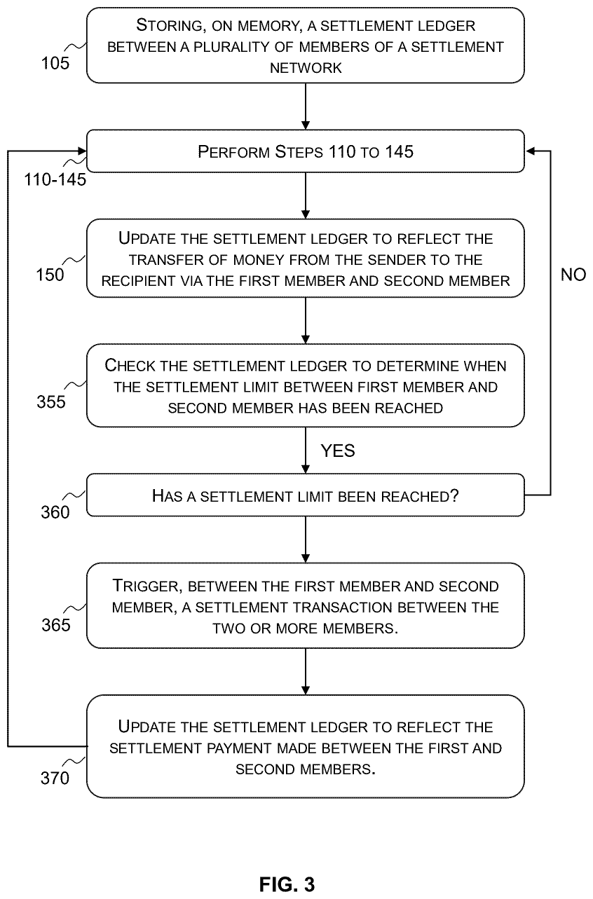

Turning now to FIG. 3 there is shown the method 100 of FIG. 1B with additional optional operations.

Firstly, Operations 105 to 150 are performed (i.e., a payment is made from a sender in a first currency to a recipient receiving the payment in a second currency, and that transaction is recorded on the settlement ledger).

Next, at Operation 355 the settlement ledger is checked to determine whether one or more of the settlement limits between two or more of the members has been reached. This operation is performed at each transaction to ensure that no transactions are made that would push the ledger between two or more of the members above the settlement limit.

At Operation 360, the settlement engine checks whether or not the settlement limit between the two or more members has been reached or not. If the settlement limit has not been reached then the method moves back to Operations 110-150 and more transactions between the two or more members may occur.

If however, the settlement limit has been reached then the settlement engine moves on to Operation 365, where a settlement transaction is triggered between the two or more members whose settlement limits have been reached. This settlement payment settles the settlement ledger between the two or more members.

The settlement ledger is then updated at Operation 370 to reflect the settlement payment made between the first and second member. The update to the settlement ledger is performed by the settlement engine by placing a lock on the part of the settlement ledger data structure to be updated, preventing any other update to that part of the settlement ledger until the update for the current settlement payment has been completed. Once completed the lock is removed.

Once the settlement ledger has been settled, the method returns to Operations 110-145 whereby more transactions may be effected between senders and recipients.

In a first aspect of the disclosed technology, there is provided a computer-implemented method for fulfilling cross payment system payments, the method comprising storing in memory a settlement ledger between a plurality of members of a settlement network, wherein each member has an entry in the settlement ledger specifying a settlement limit which is dynamically adjustable by the member. Transactions made via the members may be recorded in the settlement ledger.

Optionally, the method may further comprise receiving via a secure channel, from the members, quotes for converting between a first currency and a second currency. A notification that a sender has initiated a transfer of money to a recipient may be received via the secure channel from a first member, wherein the sender sends the money in the first currency, and wherein the recipient receives the money in the second currency.

Optionally, the method may further comprise matching, between the first member and a second member, quotes for transferring the money from the first member in the first currency to the second member in the second currency.

Optionally, further operations may include sending via the secure channel, to the first member, the matched quotes, and, receiving via the secure channel, from the first member, a notification that money has been received by the first member from the sender in the first currency.

Optionally, the method may further comprises triggering the second member, in response to receiving the notification that money has been received by the first member, to send money in the second currency to the recipient. Further operations may comprise receiving via the secure channel, from the second member, a notification that money has been transferred from the second member to the recipient in the second currency.

Optionally, the method may further comprise sending via the secure channel, to the first member, a notification that the second member has transferred money to the recipient in the second currency.

Optionally, the settlement ledger may be updated to reflect the transfer of money from the sender to the recipient via the first member and second member.

The method beneficially provides a means of reducing the number of transactions required between members (i.e., payment service providers) when acting as intermediaries between senders and recipients in jurisdictions that use different payment systems. Reducing the number of transactions has the effect of improving security as each individual transfer between two members has an associated security risk. Additionally, the method also increases scalability as an indefinite volume of transactions may be made before any settlement payment is made. The method allows members to “owe” each other money which is recorded in the settlement ledger. Each transaction (which ever direction the transaction is going in) is recorded in the settlement ledger, therefore, sporadic settlement payments can be used by members to repay each other once a settlement limit has been reached. Traditional methods would require a transaction to occur between the members to allow money to flow from the sender to the recipient. This method allows members to keep a log (i.e., the settlement ledger) of all transactions effected on each other's behalf. Payments going in both directions (e.g., first member to second member, and, second member to first member) can offset each other, allowing large numbers of transactions to be effected before any settlement payments need to be paid between the members.

In some preferred example embodiments, all the members can securely view the settlement ledger. This beneficially provides a method where all members can view, in real time, how much they owe or are owed.

In some preferred example embodiments, the method further comprises publishing, to the members, the updates to the settlement ledger in real time, wherein the updates are recorded on the settlement ledger in real time. This beneficially permits all members to know how much they owe or are owed to/from the other members in real time. This may permit the members to be able to ascertain what settlement limits they should have the other members.

In some preferred example embodiments, the method further comprises checking the settlement ledger to determine when one of the settlement limits between two or more of the members has been reached. By checking the settlement ledger, the method may inform the members when they have reached one or more of their settlement limits, or may warn them when they are close to one or more of their settlement limits.

In some preferred example embodiments, the method further comprises triggering between the two or more members whose settlement ledgers have been reached, a settlement transaction between the two or more members. This beneficially allows the settlement ledger to be settled as quickly as possible, permitting the members to continue transferring money between senders and recipients.

In some preferred example embodiments, the settlement transaction is in an agreed currency, and the agreed currency may be the same for all settlement transactions. The agreed settlement transaction currency may be the same regardless of what the first currency and second currency are.

In some preferred example embodiments, the notifications are recorded in another portion of the memory accessible to the members via a secure access mechanism. Notifications may include details about the transaction. For example, the notification may include details of the sender, the recipient, the first member, the second member, the sum of the payment, the currency conversion rates, or any other information that is pertinent to the transaction. Recording the notifications in the memory provides a database of all notifications sent between the system and the members, and permits members to see all information related to historical transactions.

In some preferred example embodiments, the quotes are streamed over a secure communication channel and reflect the live exchange rate for converting between the first currency and a settlement currency, and between the settlement currency and the second currency. The quotes may be streamed and updated at a rate that matches the rate at which the exchange market updates its exchange rates. Receiving live real time quotes from the members permits the method to match the “best” quote for a specific transaction.

In some preferred example embodiments, the method further comprises locking in the quotes for a predetermined period of time. The predetermined period of time may be adjustable and may change the rates which are quoted. Locking in a quote may permit a sender to spend a period of time before confirming that they wish to continue with the transaction. The sender may be provided with a different quote depending on how long they wish to lock in the quote for before confirming the transaction.

In some preferred example embodiments, a payment system used by the first member in the first currency may be different to the payment system used by the second member in the second currency. The method beneficially permits senders to send money to recipients in different jurisdictions that use different payment systems. This method allows for the transfer of money without the time and costs downsides associated with the prior art.

In some preferred example embodiments, a settlement from one of the members may settle the settlement ledger for more than one of the members, thereby reducing the number of settlements required to settle the settlement ledger. This beneficially further reduces the total number of transactions required to settle the settlement ledger. For example, several members could all owe each other money (e.g., member A owes member B $100,000, and member B owes member C $100,000). Instead of member A paying member B $100,000, and member B paying member C $100,000 (i.e., two transactions), member A may pay member C $100,000, thus settling the ledger for all three members in one transaction. As explained above, this beneficially provides a more secure system that requires less transactions.

In some preferred embodiments, a central counterparty may make the settlement transactions on behalf of one or more of the members.

In some preferred example embodiments, the method further comprises dividing the quotes into bands denoting the value of the transaction. For example, different quotes may be provided depending on the value of the transaction.

In some preferred example embodiments, the members may be payment service providers configured to act as intermediaries for payments.

In some preferred example embodiments, each member may have a plurality of entries in the settlement ledger specifying a plurality of settlement limits which are dynamically adjustable by the member, and wherein each of the plurality of entries and settlement limits may be associated with the member and another member. As described above, the settlement ledger may comprise a plurality of members who all hold individual ledgers with specific settlement limits with each member. This allows members to dictate the settlement limit they wish to have with the other members.

Another aspect of the disclosed technology comprises a computer-implemented system for fulfilling cross payment system payments, the system comprising one or more processors; and memory operably coupled to the one or more processors, wherein the memory is configured to store a settlement ledger between a plurality of members of a settlement network, and wherein transactions made between the one or more members are recorded on the settlement ledger, and wherein the memory is further configured to store instructions, when executed by the one or more processors, perform operations including receiving via a secure channel, from the plurality of members, one or more quotes for converting between a first currency and a settlement currency, and between the settlement currency and a second currency; receiving via the secure channel, from a first member, a notification that a sender has initiated a transfer of money to a recipient, wherein the sender sends the money in the first currency, and wherein the recipient receives the money in the second currency; matching, between the first member and a second member, quotes for transferring the money from the first member in the first currency to the second member in the second currency; sending via the secure channel, to the first member, the matched quotes; receiving via the secure channel, from the first member, a notification that money has been received by the first member from the sender in the first currency; triggering the second member, in response to receiving the notification that money has been received by the first member, to send money in the second currency to the recipient; receiving via the secure channel, from the second member, a notification that money has been transferred from the second member to the recipient in the second currency; sending via the secure channel, to the first member, a notification that the second member has transferred money to the recipient in the second currency; and updating the settlement ledger in the memory to reflect the transfer of money from the sender to the recipient via the first member and second member.

The system beneficially provides a means of reducing the number of transactions required between members (i.e., payment service providers) when acting as intermediaries between senders and recipients in jurisdictions that use different payment systems. Reducing the number of transactions has the effect of improving security as each individual transfer between two members has an associated security risk. The method allows members to “owe” each other money which is recorded in the settlement ledger. Each transaction (which ever direction the transaction is going in) is recorded in the settlement ledger, therefore, sporadic settlement payments can be used by members to repay each other once a settlement limit has been reached. Traditional methods would require a transaction to occur between the members to allow money to flow from the sender to the recipient. This method allows members to keep a log (i.e., the settlement ledger) of all transactions effected on each other's behalf. Payments going in both directions (e.g., first member to second member, and, second member to first member) can offset each other, allowing large numbers of transactions to be effected before any settlement payments need to be paid between the members.

An additional benefit of the system is the reduction of the number of technologies and independent systems involved in making cross payment system payments. Traditional systems require all members to record all transactions on their own internal ledgers-this includes transactions made between a sender and recipient via the members, and settlement payments made between the members. This leads to increases in errors being made if internal ledgers don't match up with each other. By utilising a singular settlement ledger (i.e. only one settlement ledger) between all the members, the number of errors and mistakes made in the recording of transactions is reduced. This in turn reduces the computational resources required to correct mistakes. The system additionally increases the speed at which transactions are made between members.

In some preferred example embodiments, all members of the settlement network may securely view the settlement ledger. This beneficially provides a method where all members can view, in real time, how much they owe or are owed. This beneficially permits all members to know how much they owe or are owed to/from the other members in real time. This may permit the members to be able to ascertain what settlement limits they should have the other members.

In some preferred example embodiments, the one or more processors may be further configured to check the settlement ledger to determine when one of the settlement limits between two or more of the members has been reached. By checking the settlement ledger, the method may inform the members when they have reached one or more of their settlement limits, or may warn them when they are close to one or more of their settlement limits.

In some preferred example embodiments, the one or more processors may be further configured to trigger, between the two or more members whose settlement limits have been reached, a settlement transaction between the two or more members. This beneficially allows the settlement ledger to be settled as quickly as possible, permitting the members to continue transferring money between senders and recipients.

In some preferred example embodiments, the one or more processors may be further configured to record the notifications in another portion of the memory accessible to the members via a secure access mechanism on the settlement network. For example, the notification may include details of the sender, the recipient, the first member, the second member, the sum of the payment, the currency conversion rates, or any other information that is pertinent to the transaction. Recording the notifications in the memory provides a database of all notifications sent between the system and the members, and permits members to see all information related to historical transactions.

In some preferred example embodiments, the one or more processors may be configured to receive the quotes via a secure communication channel in real time to reflect a live exchange rate for converting between the first currency and the settlement currency, and between the settlement currency and the second currency. Receiving live real time quotes from the members permits the system to match the “best” quote for a specific transaction.

Another aspect of the disclosed technology comprises a non-transitory computer-readable medium comprising instructions which, when executed by one or more processors, cause the one or more processors to perform operations including receiving, from the plurality of members, one or more quotes for converting between a first currency and a settlement currency, and between the settlement currency and a second currency; receiving via the secure channel, from a first member, a notification that a sender has initiated a transfer of money to a recipient, wherein the sender sends the money in the first currency, and wherein the recipient receives the money in the second currency; matching, between the first member and a second member, quotes for transferring the money from the first member in the first currency to the second member in the second currency; sending via the secure channel, to the first member, the matched quotes; receiving via the secure channel, from the first member, a notification that money has been received by the first member from the sender in the first currency; triggering the second member, in response to receiving the notification that money has been received by the first member, to send money in the second currency to the recipient; receiving via the secure channel, from the second member, a notification that money has been transferred from the second member to the recipient in the second currency; sending via the secure channel, to the first member, a notification that the second member has transferred money to the recipient in the second currency; and updating a settlement ledger stored in a memory to reflect the transfer of money from the sender to the recipient via the first member and second member, wherein all transactions between members are recorded on the settlement ledger.

Another aspect of the disclosed technology comprises a method for fulfilling cross payment system payments, the method comprising storing a settlement ledger between a plurality of members of a settlement network, wherein each member has an entry in the ledger specifying a settlement limit which is dynamically adjustable by the member, and wherein each transaction between two or more of the members is recorded in the ledger; publishing, to the members, updates to the ledger; receiving, from the members in real time, quotes for exchanging a local currency to a settlement currency; receiving, from a first member, a notification of receipt of a payment in a local currency; matching a quote to the incoming transaction; recording a set of events in the ledger; triggering the second member to pay a recipient in a second local currency; recording the events in the ledgers; and repeating operations until the settlement limits have been reached.

It will also be apparent to anyone of ordinary skill in the art, that some of the preferred features indicated above as preferable in the context of one of the aspects of the disclosed technology indicated may replace one or more preferred features of other ones of the preferred aspects of the disclosed technology. Such apparent combinations are not explicitly listed above under each such possible additional aspect for the sake of conciseness.

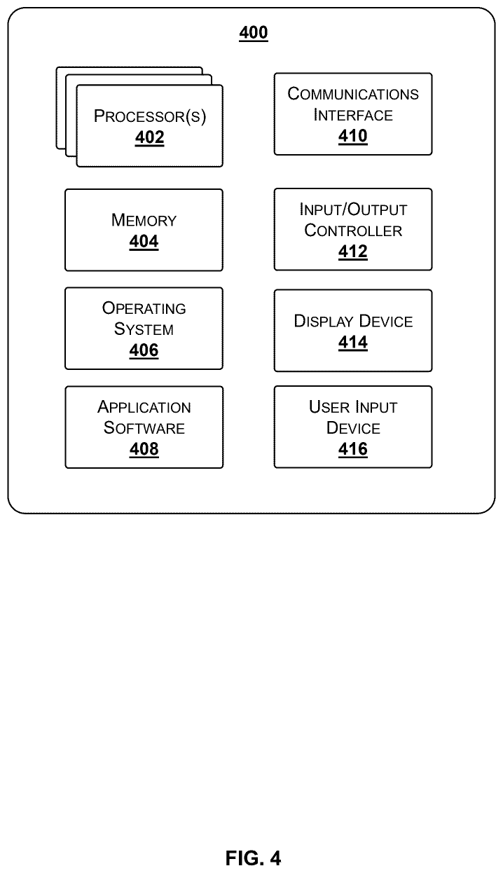

FIG. 4 illustrates various components of an example computing device 400 in which embodiments of a settlement engine are implemented in some examples. The computing device is of any suitable form such as a compute node of a data centre, a server in a cluster of servers, an on premise server, a web server or other computing device.

The computing device 400 comprises one or more processors 402 which are microprocessors, controllers or any other suitable type of processors for processing computer executable instructions to control the operation of the device in order to perform the methods of FIGS. 1B to 3 for managing a settlement ledger and implementing cross payment system payments securely. In some examples, for example where a system on a chip architecture is used, the processors 402 include one or more fixed function blocks (also referred to as accelerators) which implement a part of the method of FIGS. 1B to 3 in hardware (rather than software or firmware). That is, the methods described herein are implemented in any one or more of software, firmware, hardware. The computing device has a data store holding cryptographic keys, certificates, network addresses of member computing systems, registration details of member computing systems. The computing device has a communications interface such as a wired or wireless communications link to enable communication with a settlement ledger. Platform software comprising an operating system 406 or any other suitable platform software is provided at the computing-based device to enable application software 408 to be executed on the device. Although the computer storage media (memory 404) is shown within the computing-based device 400 it will be appreciated that the storage is, in some examples, distributed or located remotely and accessed via a network or other communication link (e.g. using communication interface 410).

The computing-based device 400 also comprises an input/output controller 412 arranged to output display information to a display device 414 which may be separate from or integral to the computing-based device 400. The display information may provide a graphical user interface such as to display information from the settlement ledger, quotes, or other data.

Any reference to ‘an’ item refers to one or more of those items. The term ‘comprising’ is used herein to mean including the method blocks or elements identified, but that such blocks or elements do not comprise an exclusive list and an apparatus may contain additional blocks or elements and a method may contain additional operations or elements. Furthermore, the blocks, elements and operations are themselves not impliedly closed.

The operations of the methods described herein may be carried out in any suitable order, or simultaneously where appropriate. The arrows between boxes in the figures show one example sequence of method operations but are not intended to exclude other sequences or the performance of multiple operations in parallel. Additionally, individual blocks may be deleted from any of the methods without departing from the spirit and scope of the subject matter described herein. Aspects of any of the examples described above may be combined with aspects of any of the other examples described to form further examples without losing the effect sought. Where elements of the figures are shown connected by arrows, it will be appreciated that these arrows show just one example flow of communications (including data and control messages) between elements. The flow between elements may be in either direction or in both directions.

Where the description has explicitly disclosed in isolation some individual features, any apparent combination of two or more such features is considered also to be disclosed, to the extent that such features or combinations are apparent and capable of being carried out based on the present specification as a whole in the light of the common general knowledge of a person skilled in the art, irrespective of whether such features or combinations of features solve any problems disclosed herein. In view of the foregoing description it will be evident to a person skilled in the art that various modifications may be made within the scope of the invention.

1. A computer-implemented method for fulfilling cross payment system payments, the method comprising:
storing on memory a settlement ledger between a plurality of members of a settlement network, wherein each member has an entry in the settlement ledger specifying a settlement limit which is dynamically adjustable by the member, and wherein transactions made via the members are recorded in the settlement ledger;
receiving via a secure channel, from the members, quotes for converting between a first currency and a settlement currency, and between the settlement currency and a second currency;
receiving via the secure channel, from a first member, a notification that a sender has initiated a transfer of money to a recipient, wherein the sender sends the money in the first currency, and wherein the recipient receives the money in the second currency;
matching, between the first member and a second member, quotes for transferring the money from the first member in the first currency to the second member in the second currency;
sending via the secure channel, to the first member, the matched quotes;
receiving via the secure channel, from the first member, a notification that money has been received by the first member from the sender in the first currency;
triggering the second member, in response to receiving the notification that money has been received by the first member, to send money in the second currency to the recipient;
receiving via the secure channel, from the second member, a notification that money has been transferred from the second member to the recipient in the second currency;
sending via the secure channel, to the first member, a notification that the second member has transferred money to the recipient in the second currency; and
updating the settlement ledger in the memory to reflect the transfer of money from the sender to the recipient via the first member and second member.

2. The method as claimed in claim 1, wherein the settlement ledger is secure and viewable only by the members.

3. The method as claimed in claim 2, further comprising publishing, to the members, the updates to the settlement ledger in real time, wherein the updates are recorded on the settlement ledger in real time.

4. The method of claim 1, further comprising checking the settlement ledger to determine when one of the settlement limits between two or more of the members has been reached.

5. The method of claim 4, further comprising triggering, between the two or more members whose settlement limits have been reached, a settlement transaction between the two or more members.

6. The method of claim 1, wherein the notifications are recorded in another portion of the memory accessible to the members via a secure access mechanism on the settlement network.

7. The method of claim 1, wherein the quotes are streamed over a secure communication channel and reflect a live exchange rate for converting between the first currency and the second currency.

8. The method of claim 7, further comprising locking in the quotes for a predetermined period of time.

9. The method of claim 1, wherein a payment system used by the first member in the first currency is different to the payment system used by the second member in the second currency.

10. The method of claim 1, wherein one settlement from one of the members settles the settlement ledger for more than one of the members, thereby reducing the number of settlements required to settle the settlement ledger.

11. The method of claim 1, further comprising dividing the quotes into bands denoting the value of the transaction.

12. The method of claim 1, wherein the members are payment service providers configured to act as intermediaries for payments.

13. The method of claim 1, wherein each member has a plurality of entries in the settlement ledger specifying a plurality of settlement limits which are dynamically adjustable by the member, and wherein each of the plurality of entries and settlement limits are associated with the member and another member.

14. A computer-implemented system for fulfilling cross payment system payments, the system comprising:
one or more processors; and
memory operably coupled to the one or more processors, wherein the memory is configured to store a settlement ledger between a plurality of members of a settlement network, and wherein transactions made between the one or more members are recorded on the settlement ledger, and wherein the memory is further configured to store instructions, when executed by the one or more processors, perform operations including:
receiving via a secure channel, from the plurality of members, one or more quotes for converting between a first currency and a settlement currency, and between the settlement currency and a second currency;
receiving via the secure channel, from a first member, a notification that a sender has initiated a transfer of money to a recipient, wherein the sender sends the money in the first currency, and wherein the recipient receives the money in the second currency;
matching, between the first member and a second member, quotes for transferring the money from the first member in the first currency to the second member in the second currency;
sending via the secure channel, to the first member, the matched quotes;
receiving via the secure channel, from the first member, a notification that money has been received by the first member from the sender in the first currency;
triggering the second member, in response to receiving the notification that money has been received by the first member, to send money in the second currency to the recipient;
receiving via the secure channel, from the second member, a notification that money has been transferred from the second member to the recipient in the second currency;
sending via the secure channel, to the first member, a notification that the second member has transferred money to the recipient in the second currency; and
updating the settlement ledger in the memory to reflect the transfer of money from the sender to the recipient via the first member and second member.

15. The system of claim 14, wherein all the members of the settlement network can securely view the settlement ledger.

16. The system of claim 14, wherein the one or more processors are further configured to check the settlement ledger to determine when one of the settlement limits between two or more of the members has been reached.

17. The system of claim 16, wherein the one or more processors are further configured to trigger, between the two or more members whose settlement limits have been reached, a settlement transaction between the two or more members.

18. The system of claim 14, wherein the one or more processors are further configured to record the notifications in another portion of the memory accessible to the members via a secure access mechanism on the settlement network.

19. The system of claim 14, wherein the one or more processors are configured to receive the quotes via a secure communication channel in real time to reflect a live exchange rate for converting between the first currency and the settlement currency, and between the settlement currency and the second currency.

20. A non-transitory computer-readable medium comprising instructions which, when executed by one or more processors, cause the one or more processors to perform operations comprising:
receiving, from the plurality of members, one or more quotes for converting between a first currency and a settlement currency, and between the settlement currency a second currency;
receiving via the secure channel, from a first member, a notification that a sender has initiated a transfer of money to a recipient, wherein the sender sends the money in the first currency, and wherein the recipient receives the money in the second currency;
matching, between the first member and a second member, quotes for transferring the money from the first member in the first currency to the second member in the second currency;
sending via the secure channel, to the first member, the matched quotes;
receiving via the secure channel, from the first member, a notification that money has been received by the first member from the sender in the first currency;
triggering the second member, in response to receiving the notification that money has been received by the first member, to send money in the second currency to the recipient;
receiving via the secure channel, from the second member, a notification that money has been transferred from the second member to the recipient in the second currency;
sending via the secure channel, to the first member, a notification that the second member has transferred money to the recipient in the second currency; and
updating a settlement ledger stored in a memory to reflect the transfer of money from the sender to the recipient via the first member and second member, wherein all transactions between members are recorded on the settlement ledger.
